(19) United States
(12) Patent Application Publication
(10) Pub. No.: US 2018/0269467 A1
(43) Pub. Date: Sep. 20, 2018

(54) CONDUCTIVE COMPOSITION FOR ELECTRODE, ELECTRODE FOR NONAQUEOUS CELL, AND NONAQUEOUS CELL

(71) Applicant: Denka Company Limited, Tokyo (JP)

(72) Inventors: Takashi SONODA, Tokyo (JP); Hisataka TAGAMI, Tokyo (JP); Yuki NAKO, Tokyo (JP); Hiroshi YOKOTA, Tokyo (JP)

(73) Assignee: Denka Company Limited, Tokyo (JP)

(21) Appl. No.: 15/532,879

(22) PCT Filed: Dec. 4, 2015
(86) PCT No.: PCT/JP2015/084168

§ 371 Date: Jul. 7, 2017

(30) Foreign Application Priority Data
Dec. 4, 2014 (JP) 2014-245961

(51) Int. Cl. H01M 4/131; H01M 4/62; H01M 4/525; H01M 4/505; H01M 10/0525

(52) U.S. Cl. CPC H01M 4/131; H01M 4/625; H01M 4/525; H01M 2004/028; H01M 4/623; H01M 10/0525; H01M 4/505

(57) ABSTRACT

By using a conductive composition for an electrode comprising a carbon black wherein the localized electron spin density per unit mass at 23° C. is 18.0×10¹⁶/m² or less and the BET specific surface area is 30 m²/g or more and 120 m²/g or less, an active material which can intercalate and deintercalate a cation, and a binder, high durability is realized while the output properties of cells are maintained.

### TECHNICAL FIELD

The present invention relates to conductive compositions for electrodes, electrodes for nonaqueous cells, and nonaqueous cells.

### BACKGROUND ART

Nonaqueous electrolyte solutions represented by carbonate-based organic electrolyte solutions such as ethylene carbonate, diethyl carbonate, and the like have potential windows wider than those of aqueous electrolyte solutions. For this reason, nonaqueous cells using these nonaqueous electrolyte solutions can demonstrate higher voltage than that of aqueous cells using conventional aqueous electrolyte solutions. Among these, a lithium ion secondary cell having a positive electrode and a negative electrodes formed using a material enabling intercalation and deintercalation of lithium ions has the advantages of excellent capacitance density in addition to high voltage, and as a result, providing a cell having high energy density and high output density.

In recent years, a further enhancement in energy density and output density of the lithium ion secondary cell is required. As one measure for realizing this, a method for obtaining high output density even at low current density by using a positive active material having a higher discharge voltage than that of conventional positive active materials has been examined. For example, a high discharge voltage of about 4.5 V can be realized by using lithium nickel manganate (LiNi_{0.5}Mn_{1.5}O₂) having a spinel type crystal structure as a positive active material.

However, if a positive active material having such a high potential is used, the positive electrode and the electrolyte solution near the positive electrode are under a strong oxidation environment; for this reason, there are problems in that even if a nonaqueous electrolyte solution is used, a side reaction such as a decomposition reaction of the electrolyte solution proceeds to reduce the life of the cell.

To reduce the side reaction to improve the life of the cell, for example, Patent Literature 1 has a disclosure of a positive electrode material for a lithium ion secondary cell in which the surface of the positive electrode material is coated with a phosphorus compound. Moreover, Patent Literature 2 has a disclosure of a carbonate compound having a fluorine atom as an electrolyte solution.

Moreover, Patent Literature 3 has a disclosure of a nonaqueous electrolyte cell in which at least part of particles of an active material and a conductive material is coated with a lithium ion conductive glass. Moreover, Patent Literature 4 has a disclosure of a lithium ion secondary cell in which a surface layer of a positive electrode current collector is coated with lithium fluoride.

### CITATION LIST

### Patent Literature

### Patent Literature 1: Japanese Unexamined Patent Publication No. 2015-162356

### Patent Literature 2: Japanese Unexamined Patent Publication No. 2014-182951

### Patent Literature 3: Japanese Unexamined Patent Publication No. 2003-173770

### Patent Literature 4: Japanese Unexamined Patent Publication No. 2013-69442

### SUMMARY OF INVENTION

### Technical Problem

Carbon black has been conventionally used as a conductive material for secondary cells. However, if a positive active material having high potential is used as described above, the conductive material carbon black has a large contact area with the electrolyte solution, and provides a cause that a side reaction such as decomposition by oxidation of the electrolyte solution readily occurs.

The methods according to Patent Literatures 1 and 2 both have provided no improvement in carbon black, and the effect of reducing the side reaction is insufficient. Moreover, because the surface of carbon black is coated in both of the methods according to Patent Literatures 3 and 4, sufficient electron conductivity may not be ensured.

In consideration of the above problems and circumstances, an object of the present invention is to provide a nonaqueous cell using a positive active material used in high potential, particularly a conductive composition for an electrode which reduces a side reaction in the lithium ion secondary cell such as a decomposition reaction of an electrolyte solution, an electrode for a nonaqueous cell using this, and a nonaqueous cell having excellent output properties and durability.

### Solution to Problem

Namely, the present invention employs the following means to solve the problems above described.

(1) A conductive composition for an electrode, comprising:
a carbon black;
an active material which can intercalate and deintercalate a cation; and
a binder,
wherein a localized electron spin density of the carbon black per unit surface area at 23° C. is 18.0×10¹⁶/m² or less, and a BET specific surface area of the carbon black is 30 m²/g or more and 120 m²/g or less.
(2) The conductive composition for an electrode according to (1), wherein the active material is a composite metal oxide having a spinel type crystal structure and represented by formula (1):

AₓM_{y}Ni_{z}Mn_{(2-y-z)}O₄ (1)

wherein A is one or more elements selected from the group consisting of Li, Na, and K; M is one or more elements selected from the group consisting of Ti, V, Cr, Fe, Co, and Zn; x, y, and z each satisfy 0<x≤1, 0≤y, 0<z, and y+z<2.
(3) The conductive composition for an electrode according to (1) or (2), wherein the carbon black is acetylene black.
(4) An electrode for a nonaqueous cell comprising:
a metal foil; and
a coating of the conductive composition for an electrode according to any one of (1) to (3) disposed on the metal foil.
(5) A nonaqueous cell comprising the electrode for a nonaqueous cell according to (4) in at least one of a positive electrode and a negative electrode.

### Advantageous Effects of Invention

The present inventors, who have conducted extensive research, have found that a nonaqueous cell using a conductive composition for an electrode comprising a carbon black having a localized electron spin density and a BET specific surface area in specific ranges has excellent output properties, reduces the side reaction such as a decomposition reaction of an electrolyte solution even if a positive active material having high potential is used, and has excellent durability.

### BRIEF DESCRIPTION OF DRAWINGS

FIG. 1 is a diagram illustrating a method of calculating the number of conduction electron spins and the number of localized electron spins from the total number of electron spins at each temperature.

FIG. 2 is an ESR spectrum (derivation format) of carbon black in Example 1.

### DESCRIPTION OF EMBODIMENTS

Hereinafter, suitable embodiments of the present invention will be described in detail. The conductive composition for an electrode according to the present embodiment is a composition comprising a carbon black, an active material which can intercalate and deintercalate a cation, and a binder.

The carbon black according to the present embodiment may be selected from acetylene black, furnace black, and channel black, like standard carbon black as a conductive material for a cell. Among these, acetylene black having excellent crystallinity and purity is more preferred.

The present inventors, who have conducted extensive research, have found that the localized electron spin density of the carbon black defined as below is strongly related with the side reaction such as the decomposition reaction of the electrolyte solution.

(Definition of Localized Electron Spin Density)

The localized electron spin density (D₁[/m²]) of the carbon black in the present embodiment per unit surface area is a value defined by expression (2) in which the number of localized electron spins (N₁[spins/g]) per unit mass is divided by the BET specific surface area (a_{BET}[m²/g]):

D₁=N₁/a_{BET}=(N−N_{c})/a_{BET} (2)

where N is the total number of electron spins of the carbon black per unit mass, and N_{c} is the number of conduction electron spins of the carbon black per unit mass.

(Definition of Total Number of Electron Spins)

The total number of electron spins of the carbon black per unit mass (N) is a value defined by expression (3):

N=I/I_{REF}×{s(s+1)}/{S(S+1)}×N_{REF}/M (3)

where I is the intensity of the electron spin resonance (hereinafter, ESR) signal of the carbon black, I_{REF} is the intensity of the ESR signal of a standard sample, S is the spin quantum number of the carbon black (namely, S=1/2), s is the spin quantum number of the standard sample, N_{REF} is the spin number of the standard sample, and M is the mass of the carbon black.

Although the type of the standard sample is not particularly limited, a polyethylene film to which an ion having a known spin quantum number is injected by an electrochemical method can be used, for example. Moreover, although the method of determining the spin number (N_{REF}) of the standard sample is not particularly limited, a method of measuring the concentration of the ion having a known spin quantum number by titration can be used, for example.

(Definition of the Number of Conduction Electron Spins)

The number of conduction electron spins (N_{c}) of the carbon black per unit mass is a value defined by expression (4):

N=A/T+N_{c} (4)

where A is a constant, and T is an absolute temperature [K] of the carbon black.

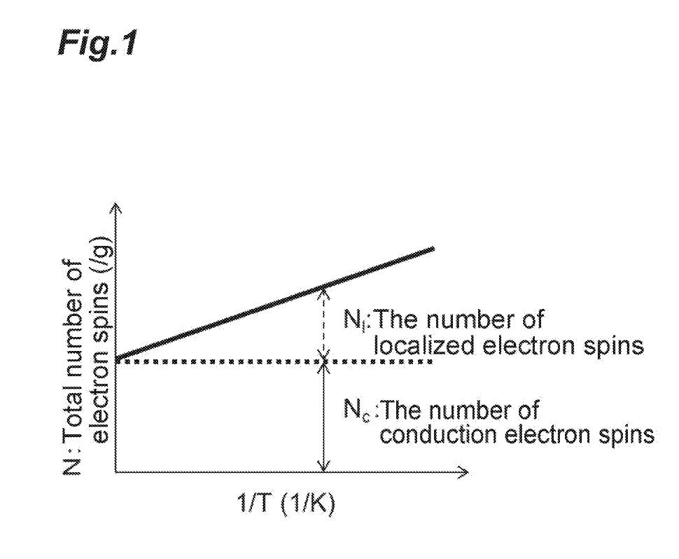

Namely, the number of conduction electron spins (N_{c}) of the carbon black can be determined, for example as follows. First, the total number of electron spins (N) of the carbon black is measured at two or more different temperatures. Next, as illustrated in FIG. 1, a graph is created in which N is plotted as the ordinate and the inverse number (1/T) of the measured temperature represented in the unit of the absolute temperature is plotted as the abscissa. Next, the regression line of the graph is determined by the least squares method, and the value (namely, the value extrapolated to 1/T=0) of the section is defined as N_{c}.

The localized electron spin density of the carbon black according to the present embodiment per unit surface area at 23° C. is 18.0×10¹⁶/m² or less, preferably 1.0×10¹⁴ to 13.0×10¹⁶/m², more preferably 1.0×10¹⁴ to 9.0×10¹⁶/m². As the localized electron spin density is lower, the sites called lattice defects and edges which more readily cause the side reaction such as the decomposition reaction of the electrolyte solution are reduced; for this reason, an effect of reducing the side reaction is obtained.

The BET specific surface area of the carbon black according to the present embodiment is a value measured by a BET single point method using nitrogen as an adsorption gas on the condition of a relative pressure p/p₀=0.30±0.04.

The BET specific surface area of the carbon black according to the present embodiment is 30 m²/g or more and 120 m²/g or less, more preferably 40 to 80 m²/g. Because the side reaction such as the decomposition reaction of the electrolyte solution occurs on the surface of the carbon black, the reaction sites are reduced as the BET specific surface area of the carbon black is smaller; for this reason, if the BET specific surface area is 120 m²/g or less, the effect of reducing the side reaction is obtained. In contrast, if the BET specific surface area is excessively small, the side reaction such as an electrolyte solution decomposition reaction is reduced, but disadvantages occur in formation of the electron electric conductive path to impair the cell properties represented by the rate characteristics and the cycle life; for this reason, it is preferred that the BET specific surface area be 30 m²/g or more.

Although the aggregate structure (structure) of the carbon black according to the present embodiment is not particularly limited, it is preferred from the viewpoint of further improving conductivity the that the structure be larger; it is preferred from the viewpoint of better processability when the binder composition and the electrode for a nonaqueous cell are produced, the structure be smaller. Actually, the structure is generally indirectly evaluated using the amount of DBP absorbed or the amount of DBP absorbed by a compressed sample measured according to HS K6217-4. The amount of DBP absorbed by the carbon black according to the present embodiment is preferably 80 to 250 g/100 mL, and the amount of DBP absorbed by the compressed sample is preferably 55 to 190 g/100 mL.

Although the volume resistivity of the carbon black according to the present embodiment is not particularly limited, it is preferred from the viewpoint of further improving the conductivity that the volume resistivity be lower. Specifically, the volume resistivity measured under compression at 7.5 MPa is preferably 0.30 Ω·cm or less, more preferably 0.25 Ω·cm or less.

Although the ash content and the moisture content of the carbon black according to the present embodiment are not particularly limited, it is preferred from the viewpoint of further reducing the side reaction that both of the ash content and the moisture content be smaller. Specifically, the ash content in the carbon black is preferably 0.04% by mass or less, and the moisture content in the carbon black is preferably 0.10% by mass or less.

The active material according to the present embodiment is selected from a positive active material in which the cation is removed during charging, and a negative electrode active material to which the cation is inserted during charging; as the cation, a lithium ion, a sodium ion, and a potassium ion are preferred, and among these, particularly a lithium ion is preferred for practical use. The positive active material may be a positive active material which can intercalate and deintercalate the cation. Examples of the positive active material include composite oxides having layered rock salt type structures such as lithium cobaltite, lithium nickelate, lithium nickel cobalt manganate, and lithium nickel cobalt aluminate; composite oxides having spinel structures such as lithium manganate and lithium nickel manganate; and composite oxides having olivine type structures such as iron lithium phosphate, manganese lithium phosphate, and iron manganese lithium phosphate. Among these, use of the composite metal oxide represented by formula (1) is preferred because the effect of reducing the side reaction of the present embodiment can be remarkably demonstrated. In formula (1), a composite metal oxide where A=Li, x=1, y=0, and z=0.5 is a typical lithium nickel manganate.

AₓM_{y}Ni_{z}Mn_{(2-y-z)}O₄ (1)

where A is one or more elements selected from the group consisting of Li, Na, and K, and M is one or more elements selected from the group consisting of Ti, V, Cr, Fe, Co, and Zn. Moreover, x, y, and z each satisfy 0<x≤1, 0≤y, 0<z, and y+z<2.

The negative electrode active material may be a negative electrode active material which can intercalate and deintercalate the cation. Examples of the negative electrode active material include carbon-based materials such as artificial graphite, natural graphite, soft carbon, and hard carbon; metal-based materials forming alloys with alkali metals, such as silicon and tin; and metal composite oxides such as lithium titanate.

Examples of the binder according to the present embodiment include polymers such as polyvinylidene fluoride, polytetrafluoroethylene, styrene-butadiene copolymers, polyvinyl alcohol, acrylonitrile-butadiene copolymers, and carboxylic acid-modified (meth)acrylate ester copolymers. Among these, if the binder is used in the positive electrode, polyvinylidene fluoride is preferred from the viewpoint of resistance against oxidation; if the binder is used in the negative electrode, polyvinylidene fluoride or a styrene-butadiene copolymer is preferred from the viewpoint of the adhesive force.

Examples of the dispersion medium for the conductive composition for an electrode of the present embodiment include, water, N-methyl-2-pyrrolidone, cyclohexane, methyl ethyl ketone, and methyl isobutyl ketone. N-methyl-2-pyrrolidone is preferred from the viewpoint of the solubility when polyvinylidene fluoride is used as the binder, and water is preferred when a styrene-butadiene copolymer is used.

As a mixing apparatus for producing the conductive composition for an electrode of the present embodiment, a mixer such as a grind mill, a versatile mixer, a Henschel mixer, or a ribbon blender; or a medium stirring mixer such as a bead mill, a vibration mill, or a ball mill can be used. Moreover, it is preferred that air bubbles be removed from the produced coating solution for an electrode in vacuum in a step before the application to ensure the smoothness without generating defects in the coating. If air bubbles are present in the coating solution, they are a cause to generate defects in the coating and impair the smoothness when the coating solution is applied to the electrode.

Moreover, the conductive composition for an electrode of the present embodiment can contain components other than the carbon black, the positive active material, the negative electrode active material, and the binder in the range to obtain the above effect. For example, besides the carbon black, carbon nanotubes, carbon nanofibers, graphite, graphene, graphene oxide, carbon fibers, elemental carbon, glassy carbon, and metal particles may be contained to further enhance the conductivity. Moreover, polyvinylpyrrolidone, polyvinylimidazole, polyethylene glycol, polyvinyl alcohol, poly(vinyl butyral), carboxymethyl cellulose, acetyl cellulose, or carboxylic acid-modified (meth)acrylate ester copolymer may be contained to enhance the dispersibility.

One suitable embodiment of the silica-coated carbon black according to the present invention has been described, but the present invention will not be limited to this.

For example, the present invention may relate to an electrode for a nonaqueous cell including a metal foil, and the above coating of the conductive composition for an electrode disposed on the metal foil.

The metal foil, if used as the positive electrode, may be an aluminum foil, for example. Moreover, the metal foil, if used as the negative electrode, may be a copper foil, for example. The shape of the metal foil is not particularly limited. From the viewpoint of facilitating the processability, it is preferred that the thickness of the metal foil be 5 to 30 μm.

The coating of the conductive composition for an electrode may be formed by applying the conductive composition for an electrode onto a metal foil by a method such as slot die coating, lip coating, reverse roll coating, direct roll coating, blade coating, knife coating, extrusion coating, curtain coating, gravure coating, bar coating, dip coating, and squeeze coating. Among these, slot die coating, lip coating, and reverse roll coating are preferred. The applying method may be appropriately selected according to the solution physical properties of the binder and the drying properties. The coating of the conductive composition for an electrode may be formed one surface of the metal foil, or may be formed on both surfaces thereof. If the coating of the conductive composition for an electrode is formed on both surfaces of the metal foil, the conductive composition for an electrode may be sequentially applied onto each of the surfaces of the metal foil, or may be simultaneously applied onto both surfaces of the metal foil. The aspect of application of the conductive composition for an electrode may be continuous, intermittent, or striped.

The thickness, the length, and the width of the coating of the conductive composition for an electrode may be appropriately determined according to the dimension of the cell. For example, the thickness of the coating may be in the range of 10 μm to 500 μm.

The coating of the conductive composition for an electrode may be formed by applying and drying the conductive composition for an electrode. The drying of the conductive composition for an electrode can be performed by using measures such as hot air, vacuum, infrared radiation, far-infrared radiation, electron beams, and air at low temperature alone or in combination.

The electrode for a nonaqueous cell may be pressed when necessary. A method usually used may be used as the pressing method; for example, metal mold pressing or calendar pressing (cool rolling or hot rolling) is preferred. Although the press pressure in calendar pressing is not limited, a press pressure of 0.02 to 3 ton/cm is preferred, for example.

The present invention may also relate to a nonaqueous cell including the electrode for a nonaqueous cell in at least one of a positive electrode and a negative electrode.

The nonaqueous cell may be a lithium ion secondary cell, a sodium ion secondary cell, a magnesium ion secondary cell, a nickel hydrogen secondary cell, or an electric double-layer capacitor, for example.

The present invention may also relate to a conductive material for a nonaqueous cell, comprising a carbon black wherein a localized electron spin density per unit surface area at 23° C. is 18.0×10¹⁶/m² or less, and a BET specific surface area is 30 m²/g or more and 120 m²/g or less. The present invention may also relate to use of the conductive material for a nonaqueous cell containing the carbon black. The present invention may also relate to use of the electrode for a nonaqueous cell containing the carbon black for manufacturing, and may relate to the references for manufacturing the nonaqueous cell containing the carbon black.

### EXAMPLES

Hereinafter, one embodiment of the conductive composition for an electrode according to the present invention will be described in detail by way of Examples and Comparative Examples. However, the present invention will not be limited to Examples below without departing from the gist.

### Example 1

### (Carbon Black)

In the present example, acetylene black (manufactured by Denka Company Limited, AB Powder) wherein the localized electron spin density per unit surface area at 23° C. was 5.0×10¹⁶/m² and the BET specific surface area was 68 m²/g was used as carbon black. The localized electron spin density per unit surface area and BET specific surface area of the acetylene black were measured by the following methods.

[Localized Electron Spin Density]

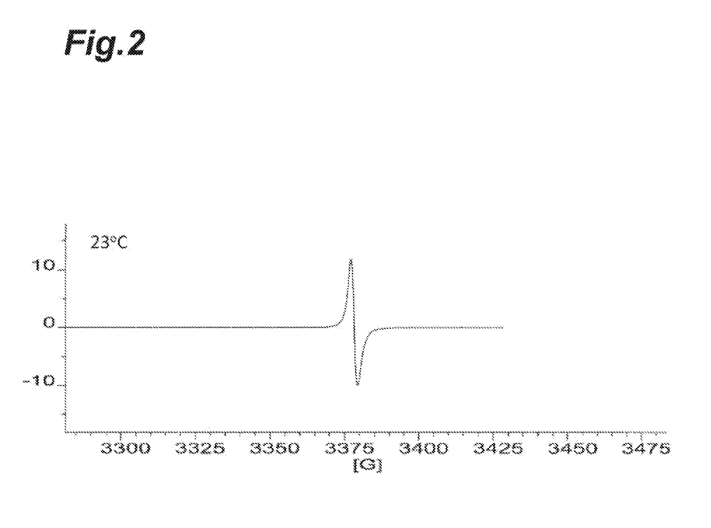

The localized electron spin density at 23° C. of the acetylene black was measured by the following method. First, the ESR signal of the carbon black was measured using an electron spin resonance measurement apparatus (manufactured by Bruker Corporation, ESP350E) on the condition of the center magnetic field of 3383 Gauss and the magnetic field sweep width of 200 Gauss at sample temperatures of −263° C., −253° C., −233° C., −173° C., −113° C., −53° C., and 23° C. Because the ESR signal is output as the derivation format illustrated in FIG. 2, the intensity of the ESR signal was calculated by integrating the ESR signal twice in the entire region. Next, the intensity of the ESR signal of an ion-injected polyethylene film having a known spin number (thickness: 300 μm, the spin number: 5.5×10¹³/g) was measured on the same conditions, and the total number of electron spins of the carbon black at the respective temperatures was calculated using this as a standard sample. Next, a graph was created in which the total number of electron spins was plotted as the ordinate and the inverse number of the sample temperature represented in the absolute temperature was plotted as the abscissa, and the number of conduction electron spins was calculated as the section of a regression line calculated by the least squares method. Next, the number of localized electron spins obtained by subtracting the value of the number of conduction electron spins from the value of the total number of electron spins at 23° C. was divided by the BET specific surface area of the acetylene black to calculate the localized electron spin density.

[BET Specific Surface Area]

The BET specific surface area of the acetylene black was measured using a nitrogen adsorption specific surface area meter (manufactured by Mountech Co., Ltd., Macsorb 1201) and nitrogen as an adsorption gas on the condition of the relative pressure p/p₀=0.30±0.04.

(Production of Conductive Composition for Electrode and Electrode for Lithium Ion Cell)

To 5 parts by mass of the acetylene black, 90 parts by mass of spinel lithium nickel manganate (LiNi_{0.5}Mn_{1.5}O₄, manufactured by Hosensha) as an active material, polyvinylidene fluoride solution (manufactured by KUREHA CORPORATION, “KF polymer (registered trademark) 1120”, solid content: 12% by mass) as a binder in an amount of 5 parts by mass of the solute, and furthermore, 30 parts by mass of N-methyl-2-pyrrolidone (manufactured by KISHIDA CHEMICAL Co., Ltd.) as a dispersion medium were added, and were mixed using a planetary centrifugal mixer (manufactured by THINKY CORPORATION, Awatorineritaro ARV-310) to obtain a conductive composition for an electrode. This conductive composition for an electrode was applied onto an aluminum foil having a thickness of 20 jam using a Baker applicator, and was dried; subsequently, the workpiece was pressed, and was cut to obtain an electrode for a lithium ion cell.

(Production of Negative Electrode)

98 parts by mass of graphite powder (manufactured by Hitachi Chemical Company, Ltd., MAG-D) as an active material, polyvinylidene fluoride solution as a binder in an amount of 2 parts by mass of the solute, and furthermore, 30 parts by mass of N-methyl-2-pyrrolidone as a dispersion medium were added, and were mixed using the planetary centrifugal mixer to obtain a binder composition for a negative electrode. This was applied onto a copper foil having a thickness of 15 μLM using the Baker applicator, and was dried; subsequently, the workpiece was pressed, and was cut to obtain a negative electrode.

(Production of Lithium Ion Cell)

The electrode for a lithium ion cell produced using the conductive composition for an electrode and cut into a length of 40 mm and a width of 40 mm was used as the positive electrode, and the negative electrode cut into a length of 44 mm and a width of 44 mm was used as the negative electrode; a non-woven fabric made of olefin fibers as a separator electrically separating these from each other and a laminate film of aluminum as an exterior were used to produce a laminate type cell. An electrolyte solution of 1 mol/L of lithium hexafluorophosphate (LiPF₆, manufactured by STELLACHEMIFA CORPORATION) dissolved in EC (ethylene carbonate, manufactured by Sigma-Aldrich Corporation) and DEC (diethyl carbonate, manufactured by Sigma-Aldrich Corporation) mixed in a volume ratio of 1:2 was used.

(Evaluation of Lithium Ion Cell)

The lithium ion cell produced above was evaluated as follows. Results are shown in Table 1. The evaluations of the cells were all performed inside a thermostat chamber at 25±1° C. Moreover, unless otherwise specified, the value for evaluation is the arithmetic average of the values of three cells.

[Coulombic Efficiency]

First, the amount (g) of the positive active material present on the positive electrode was determined from the mass of the positive electrode, and the value (mA) obtained by dividing the amount by 140 was defined as a current value “1 C”. The cell was charged at constant current and a constant voltage where the current was 0.2 C and the upper limit voltage was 5.0 V, and furthermore, the cell was discharged at a constant current where the current was 0.2 C and the lower limit voltage was 3.0 V; the ratio (%) of the discharging capacity to the charging capacity at this time was defined as coulombic efficiency. A higher coulombic efficiency indicates less side reaction such as the decomposition reaction of the electrolyte solution.

[Rate Characteristics]

The measurement of the rate characteristics was performed at the following capacity as the evaluation of output properties. As one cycle, the lithium ion cell after the measurement of coulombic efficiency was charged at a constant current and a constant voltage where the current was 0.2 C and the upper limit voltage was 5.0 V, and was discharged at a constant current where the current was 0.2 C and the lower limit voltage was 3.0 V; four cycles were repeated, and the discharging capacity of the 4th cycle was recorded as the 0.2 C discharging capacity. Next, as one cycle, the cell was charged at a constant current and a constant voltage where the current was 0.2 C and the upper limit voltage was 5.0 V, and was discharged at a constant current where the current was 5 C and the lower limit voltage was 3.0 V; four cycles were repeated, and the discharging capacity of the 4th cycle was recorded as the 5 C discharging capacity. The proportion (%) of the 5 C discharging capacity to the 0.2 C discharging capacity was defined as the rate characteristic value. A larger rate characteristic value indicates lower resistance and excellent output properties of the cell.

[Cycle Properties]

The measurement of cycle properties was performed as follows as the evaluation of the cell life. As one cycle, the lithium ion cell after the measurement of the rate characteristics was charged at a constant current and a constant voltage where the current was 1 C and the upper limit voltage was 5.0 V, and was discharged at a constant current where the current was 1 C and the lower limit voltage was 3.0 V; 200 cycles were repeated, and the proportion (%) of the discharging capacity of the 200th cycle to the discharging capacity of the 1st cycle was defined as cycle property value. If the discharging capacity was 0 in less than 200 cycles, the cycle property value of the cell was considered as 0; the arithmetic average of the values of three cells was calculated.

<Example 2>

A conductive composition for an electrode, an electrode for a lithium ion cell, and a lithium ion cell were produced in the same manner as in Example 1 except that the acetylene black in Example 1 was replaced by furnace black (manufactured by Timcal Graphite and Carbon Co., SuperPLi) wherein the localized electron spin density per unit surface area at 23° C. was 8.1×10¹⁶/m² and the BET specific surface area was 63 m²/g, and each evaluation was performed in the same manner as in Example 1. Results are shown in Table 1.

<Example 3>

Acetylene gas on the condition at 18 m³/h, oxygen gas on the condition at 4 m³/h, and hydrogen gas on the condition at 8 m³/h were mixed, and were sprayed from a nozzle disposed on the top of a carbon black production furnace (furnace length: 5 m, furnace diameter: 0.5 m); using the pyrolysis and combustion reaction of acetylene, a sample A wherein the localized electron spin density was 12.1×10¹⁶/m² and the BET specific surface area was 52 m²/g was produced. A conductive composition for an electrode, an electrode for a lithium ion cell, and a lithium ion cell were produced in the same manner as in Example 1 except that the acetylene black in Example 1 was replaced by the sample A, and each evaluation was performed in the same manner as in Example 1. Results are shown in Table 1.

### Example 4

A conductive composition for an electrode, an electrode for a lithium ion cell, and a lithium ion cell were produced in the same manner as in Example 1 except that the acetylene black in Example 1 was replaced by acetylene black (manufactured by Denka Company Limited, HS100) wherein the localized electron spin density per unit surface area at 23° C. was 16.4×10¹⁶/m² and the BET specific surface area was 39 m²/g, and each evaluation was performed in the same manner as in Example 1. Results are shown in Table 1.

### Example 5

The acetylene black in Example 4 was used as a raw material, and a heat treatment was performed under a nitrogen atmosphere in a high frequency furnace at 1800° C. for one hour to obtain a sample B wherein the localized electron spin density was 17.6×10¹⁶/m² and the BET specific surface area was 34 m²/g. A conductive composition for an electrode, an electrode for a lithium ion cell, and a lithium ion cell were produced in the same manner as in Example 1 except that the acetylene black in Example 1 was replaced by the sample B, and each evaluation was performed in the same manner as in Example 1. Results are shown in Table 1.

TABLE 1

| | | | | Example | Example | Example | Example | Example |
|---|---|---|---|---|---|---|---|---|
| | | | | 1 | 2 | 3 | 4 | 5 |
| | | Type of carbon black | | Acetylene | Furnace | Acetylene | Acetylene | Acetylene |
| | | | | black | black | black | black | black |
| | | Specific surface area | m²/g | 68 | 63 | 39 | 52 | 34 |
| | | Localized electron | ×10¹⁶/m² | 5.0 | 8.1 | 16.4 | 12.1 | 17.6 |
| | | spin density | | | | | | |
| Evaluation | Evaluation | Coulombic | % | 98 | 97 | 95 | 96 | 95 |
| | of cell | efficiency | | | | | | |
| | | Rate characteristics | % | 76 | 75 | 74 | 75 | 74 |
| | | (5 C discharging | | | | | | |
| | | capacity/0.2 C | | | | | | |
| | | discharging | | | | | | |
| | | capacity × 100) | | | | | | |
| | | Cycle life | % | 80 | 73 | 62 | 68 | 60 |
| | | (discharging | | | | | | |
| | | capacity of 200th | | | | | | |
| | | cycle/discharging | | | | | | |
| | | capacity of 1st | | | | | | |
| | | cycle × 100) | | | | | | |

### Comparative Example 1

A conductive composition for an electrode, an electrode for a lithium ion cell, and a lithium ion cell were produced in the same manner as in Example 1 except that acetylene black in Example 1 was replaced by acetylene black (manufactured by Denka Company Limited, FX35) wherein the localized electron spin density per unit surface area at 23° C. was 3.3×10¹⁶/m² and the BET specific surface area was 133 m²/g, and each evaluation was performed in the same manner as in Example 1. Results are shown in Table 2.

### Comparative Example 2

A conductive composition for an electrode, an electrode for a lithium ion cell, and a lithium ion cell were produced in the same manner as in Example 1 except that the acetylene black in Example 1 was replaced by furnace black (manufactured by Denka Company Limited) wherein the localized electron spin density per unit surface area at 23° C. was 19.6×10¹⁶/m² and the BET specific surface area was 25 m²/g, and each evaluation was performed in the same manner as in Example 1. Results are shown in Table 2.

TABLE 2

| | | | | Comparative | Comparative |
|---|---|---|---|---|---|
| | | | | Example 1 | Example 2 |
| | | Type of carbon black | | Acetylene | Furnace |
| | | | | black | black |
| | | Specific surface area | m²/g | 133 | 25 |
| | | Localized electron spin density | ×10¹⁶/m² | 3.3 | 19.6 |
| Evaluation | Evaluation | Coulombic efficiency | % | 89 | 90 |
| | of cell | Rate characteristics | % | 71 | 69 |
| | | (5 C discharging capacity/0.2 C discharging | | | |
| | | capacity × 100) | | | |
| | | Cycle life | % | 12 | 0 |
| | | (discharging capacity of 200th | | | |
| | | cycle/discharging capacity of 1st cycle × 100) | | | |

From the results of Tables 1 and 2, it was found that the lithium ion cells produced using the conductive composition for an electrode according to Examples have excellent output properties and durability.

The above results were similar in the lithium ion cell positive electrodes used in Examples, and the positive electrodes, negative electrodes, and electrodes for sodium ion secondary cells using a variety of active materials other than in the present example.

### INDUSTRIAL APPLICABILITY

By using the conductive composition for an electrode according to the present invention, a nonaqueous cell can be achieved which can reduce the side reaction such as the decomposition reaction of the electrolyte solution even if a positive active material having high potential is used, and has excellent output properties and durability.

1. A conductive composition for an electrode, comprising:
a carbon black;
an active material which can intercalate and deintercalate a cation; and
a binder,
wherein a localized electron spin density of the carbon black per unit surface area at 23° C. is 18.0×10¹⁶/m² or less, and
a BET specific surface area of the carbon black is 30 m²/g or more and 120 m²/g or less.

2. The conductive composition for an electrode according to claim 1, wherein the active material is a composite metal oxide having a spinel type crystal structure and represented by formula (1):
AₓM_{y}Ni_{z}Mn_{(2-y-z)}O₄ (1)
wherein A is one or more elements selected from the group consisting of Li, Na, and K; M is one or more elements selected from the group consisting of Ti, V, Cr, Fe, Co, and Zn; x, y, and z each satisfy 0<x≤1, 0≤y, 0<z, and y+z<2.

3. The conductive composition for an electrode according to claim 1, wherein the carbon black is acetylene black.

4. An electrode for a nonaqueous cell comprising:
a metal foil; and
a coating of the conductive composition for an electrode according to claim 1 disposed on the metal foil.

5. A nonaqueous cell comprising the electrode for a nonaqueous cell according to claim 4 in at least one of a positive electrode and a negative electrode.
